(19) United States
(12) Patent Application Publication
(10) Pub. No.: US 2020/0093685 A1
(43) Pub. Date: Mar. 26, 2020

(54) Erectile Dysfunction Assistance Device

(71) Applicant: Frank Solomon Luke, Panama City, FL (US)

(72) Inventor: Frank Solomon Luke, Panama City, FL (US)

(21) Appl. No.: 16/577,587

(22) Filed: Sep. 20, 2019

Related U.S. Application Data
(60) Provisional application No. 62/734,142, filed on Sep. 20, 2018.

(51) Int. Cl. A61H 19/00

(52) U.S. Cl. CPC A61H 19/50; A61H 19/44; A61H 2201/169; A61H 2201/0157; A61H 2201/1647; A61H 2201/0107

(57) ABSTRACT

An erectile dysfunction assistance device is an apparatus that supports the entry of a flaccid penis of a user into an orifice of a participant by widening the opening of the orifice of the participant. The apparatus includes a tubular brace, a domed insert, and a flange. The tubular brace supports the shaft of the flaccid penis and widens the orifice for the flaccid penis to be comfortably positioned within the orifice. The domed insert widens the opening of the orifice and supports the head of the penis into and within the orifice. The flange stops the tubular brace from entirely slipping past the opening of the orifice and allows a user to grasp the present invention while positioned within the orifice and around the flaccid penis. The tubular brace, the domed insert, and the flange are separable along the length of the flaccid penis for painless and easy removal.

The current application claims a priority to the U.S. Provisional Patent application Ser. No. 62/734,142 filed on Sep. 20, 2018.

### FIELD OF THE INVENTION

The present invention generally relates to tools for sexual aid. More specifically, the present invention is an erectile dysfunction assistance device.

### BACKGROUND OF THE INVENTION

In present times, individuals are known to employ various methods to counteract the effects of erectile dysfunction (ED), specifically the inability to attain and maintain an erection. This condition is generally understood to stem from many possible causes, including heart disease, clogged blood vessels, high cholesterol, diabetes, metabolic syndrome, multiple sclerosis, alcoholism, and side effects of certain medications. This condition may be treated pharmaceutically using drugs currently on the market, both in an on-label and off-label capacity. However, the drugs may be contraindicated for some individuals with certain conditions, including many of the same conditions that would cause erectile dysfunction in the first place. Surgical corrections are also known to be employed, but these methods are generally expensive and carry additional risks associated with any surgical procedure (anesthetic, infection, scar tissue, medical error, etc.). Further, the implants associated with these procedures may be uncomfortable long-term or require further surgical intervention due to improper placement or deviation over time. External prosthetic devices (e.g. strap-ons, sheaths, dildos, etc.) are also known to be employed by some individuals in an effort to copulate with a partner, but these prosthetics generally deprive the user of the full experience provided by real skin-on-skin contact.

The present invention aims to provide a tool for sufferers of ED to insert themselves into a partner, despite not being able to achieve or maintain an erection. After insertion of the user's member into the body of the present invention, the rigid nature of the invention will assist in penetration of an orifice in a partner's body. Though the ideal embodiment should be suitable to assisting penetration of a vagina, the present invention may be constructed in ways suited to a variety of users, partners, and orifices without departing from the original scope of the present invention. These various embodiments may include instances of the present invention featuring a variety of sizes, shapes, or patterns of surface contours suitable to enhancing user (or partner) comfort.

### BRIEF DESCRIPTION OF THE DRAWINGS

FIG. 1 is a top perspective view of the present invention.

FIG. 2 is a top exploded view of the present invention.

FIG. 3 is a bottom perspective view of the present invention.

FIG. 4 is a bottom exploded view of the present invention.

FIG. 5 is a front side view of the present invention.

FIG. 6 is a top side view of the present invention.

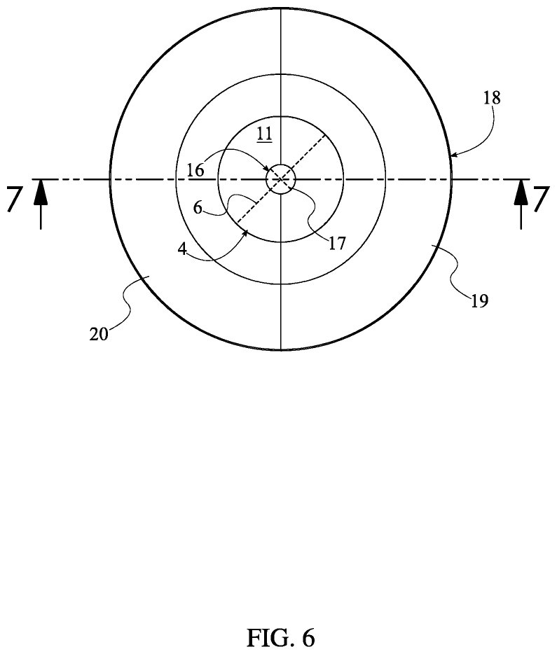

FIG. 7 is a cross-section view along line 7-7 of FIG. 6 of the present invention.

### DETAIL DESCRIPTIONS OF THE INVENTION

All illustrations of the drawings are for the purpose of describing selected versions of the present invention and are not intended to limit the scope of the present invention.

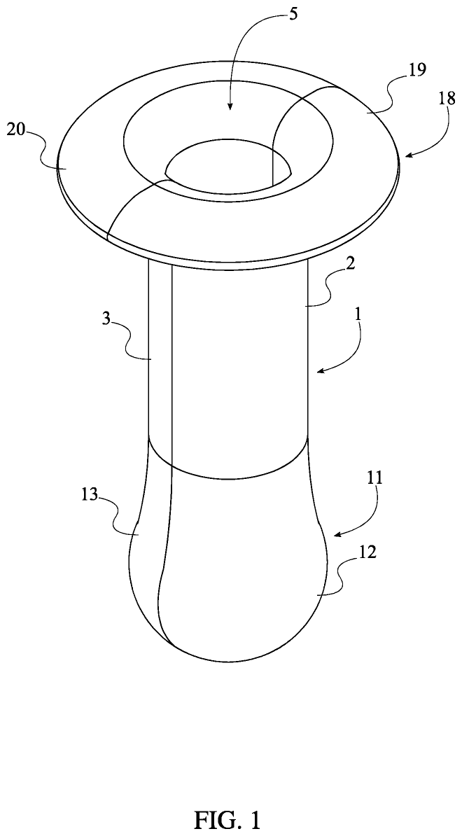

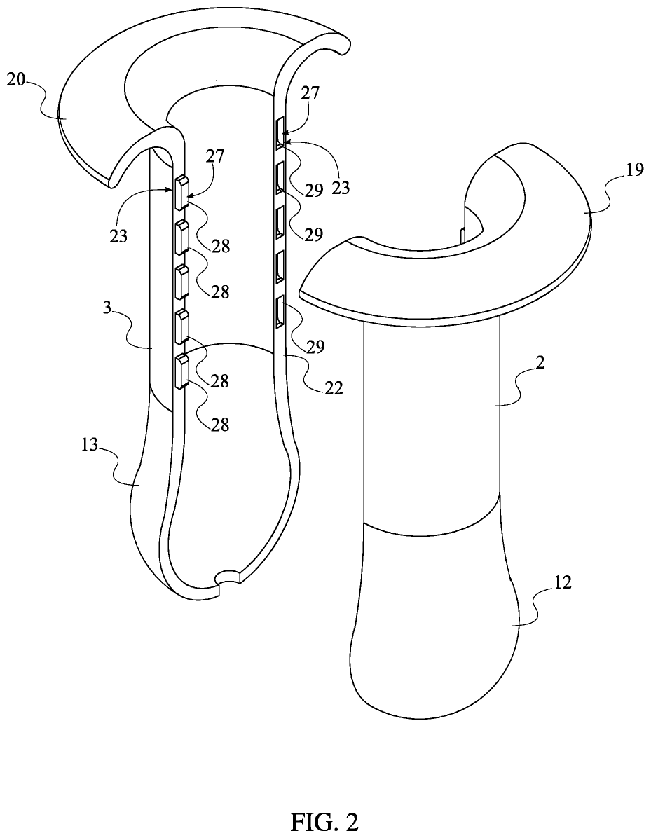

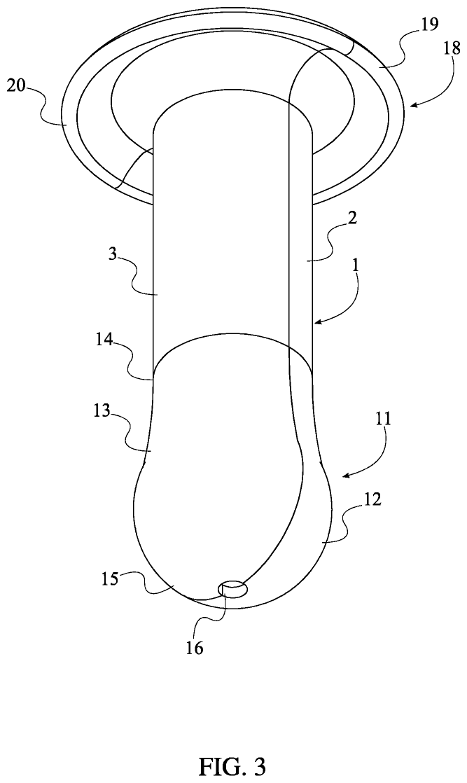

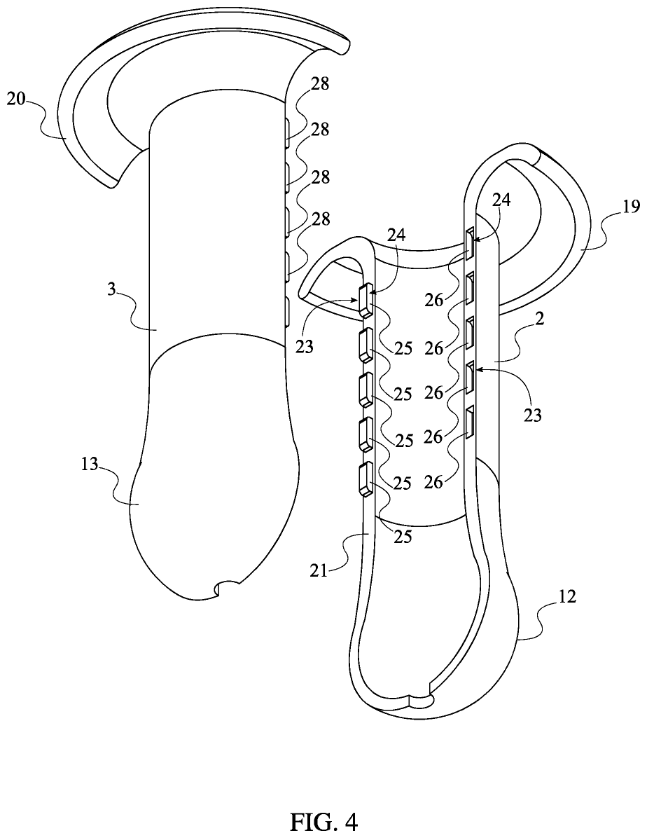

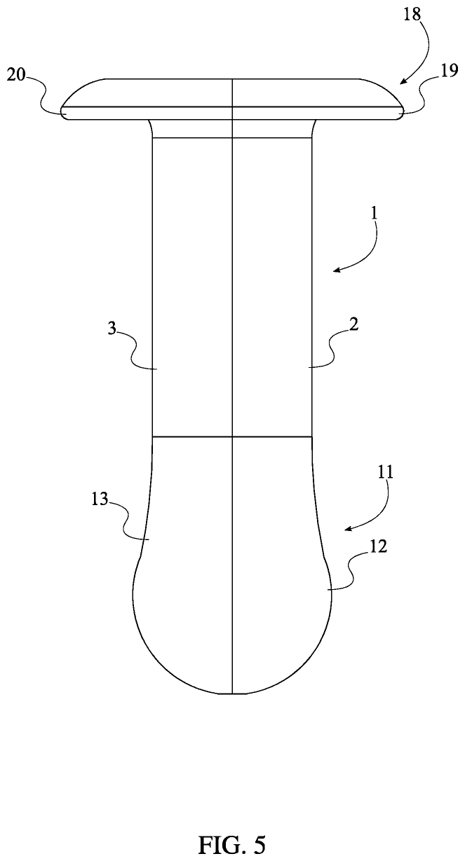

The present invention is an erectile dysfunction assistance device that aids a user with erectile dysfunction to insert the penis of a user into an orifice of a participant in order to begin sexual activity. The present invention serves as a guide for a user into an orifice of the participant without any discomfort for the user and the participant. The present invention more specifically applies the necessary force into an orifice of the participant, effectively further opening the orifice of the participant so that a flaccid penis of the user requires no firmness or stiffness to penetrate into the orifice. The present invention allows a user to begin sexual activity and is easily removed from both the penis of the user and the orifice of the participant once the penis is positioned within the orifice of the participant. In order for the penis of a user to be positioned within an orifice of a participant without any discomfort for both the user and the participant, the present invention comprises a tubular brace 1, a domed insert 11, and a flange 18, seen in FIG. 1, FIG. 2, FIG. 3, FIG. 4, and FIG. 5. The domed insert 11, the tubular brace 1, and the flange 18 are made of an elastic and flexible material. In the preferred embodiment of the present invention, the flexible material is silicone in order to provide gentle support and slight physical pleasure with the present invention to both the user and the participant. In order to effectively use the present invention, the tubular brace 1 and the domed insert 11 are positioned within the orifice of the participant. The flange 18 is positioned against the exterior of the orifice. The flaccid penis of the user is then slipped into tubular brace 1 with the shaft of the flaccid penis positioned along the tubular brace 1 and the head of the flaccid penis positioned within the domed insert 11. The user grasps the present invention by the flange 18 and the present is separated around the flaccid penis and removed from out of the orifice. The flaccid penis remains positioned within the orifice upon the separation and removal of the present invention.

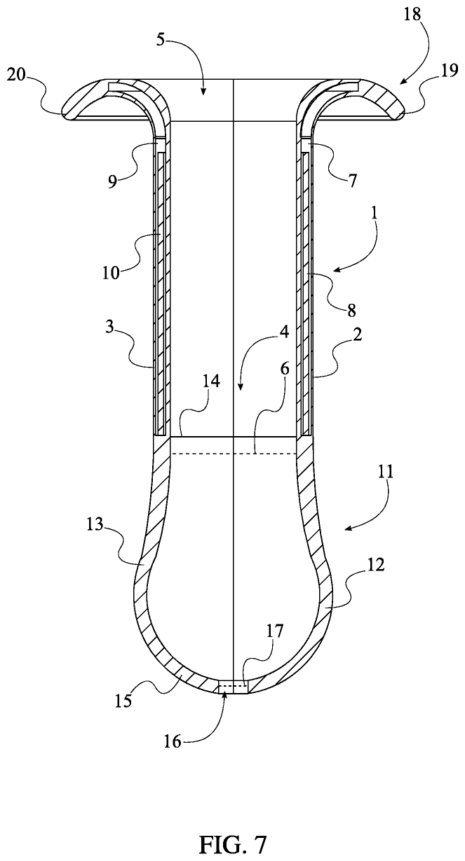

The tubular brace 1, as seen in FIG. 1, FIG. 3, FIG. 5, and FIG. 7, widens the orifice and defines a smooth and continuous entry into the orifice of the participant for the penis of the user. More specifically, the tubular brace 1 surrounds the shaft of a flaccid penis of the user. The tubular brace 1 is preferably used with lubricant in order to eliminate any possible discomfort for the participant and preferably mirrors the shape, length, and girth of the flaccid penis. The tubular brace 1 may also enhance the physical satisfaction of the participant with a variety of external grooves. In order to widen the orifice, support the shaft of the flaccid penis, and the allow the invention to be easily removable from within the orifice and from around the flaccid penis, the tubular brace 1 comprises a first elongated half portion 2, a second elongated half portion 3, a first open end 4, and a second open end 5. The first elongated half portion 2 and the second elongated half portion 3, together, defines a width of the path within the orifice so that the shaft of the flaccid penis freely and continuously slides into the orifice of the participant. The first open end 4 allows the head of the flaccid penis to traverse into the domed insert 11, and the second open end 5 is the entry point of the flaccid penis into the tubular brace 1.

The domed insert 11, as seen in FIG. 1, FIG. 3, FIG. 5, and FIG. 7, penetrates and widens the opening of the orifice and is the initial point of contact with the orifice. The domed insert 11 mirrors the head of the flaccid penis and surrounds the head of the flaccid penis. Similar to the tubular brace 1, the domed insert 11 comprises a first semispherical half portion 12 and a second semispherical half portion 13. The first semispherical half portion 12 and the second semispherical half portion 13, together, comfortably penetrate and wide the orifice of the orifice while allowing the present invention to be easily separable and removable.

The flange 18, as seen in FIG. 1, FIG. 3, FIG. 5, and FIG. 7, stops the tubular brace 1 from entirely slipping past the opening of the orifice and being completely positioned within the orifice. Furthermore, the flange 18 allows the user to grasp the present invention without further widening the opening of the orifice in order to separate and remove the present invention while the flaccid penis is effectively positioned within the orifice. The flange 18 also comprises a first semicircular half portion 19 and a second elongated semicircular half portion 20, in order for the present invention to be separable and removable.

The overall configuration of the aforementioned components effectively defines an entry into an orifice and supports the flaccid penis of a user within an orifice of a participant. In order for a widened, smooth entry into the orifice, the first semispherical half portion 12 is terminally connected to the first elongated half portion 2, adjacent to the first open end 4, seen in FIG. 1, FIG. 3, FIG. 5, and FIG. 7. The first semicircular half portion 19 is terminally connected to the first elongated half portion 2, adjacent to the second open end 5. This arrangement positions the first semicircular half portion 19 external to the orifice of the participant, stopping both the first semispherical half portion 12 and the first elongated half portion 2 from slipping past the opening of the orifice. Similarly, the second semispherical half portion 13 is terminally connected to the first elongated half portion 2, adjacent to the first open end 4, and the second semicircular half portion 20 is terminally connected to the first elongated half portion 2, adjacent to the second open end 5. This arrangement allows a flaccid penis of the user to be comfortably positioned within the orifice of the participant and the orifice to be gently widened. The first semicircular half portion 19, the first elongated half portion 2, and the first semispherical half portion 12 are removably attached with the second semicircular half portion 20, the second elongated half portion 3, and the second semispherical half portion 13, respectively, so that the present invention may be smoothly and easily removed.

The present invention supports the head of a flaccid penis and mirrors the structure of the head of the flaccid penis in order for comfortable support and smooth entry as the domed insert 11 further comprises an insert apex 14, an insert base 15, and an outlet aperture 16, seen in FIG. 3 and FIG. 7. The insert base 15 is positioned adjacent to the first open end 4, and the insert apex 14 is positioned opposite to the insert base 15 about the domed insert 11. The outlet aperture 16 traverses through the insert apex 14 for any pre-ejaculation fluid to enter into the orifice. The domed insert 11 further accommodates the natural structure of a penis as a radius 17 of the outlet aperture 16 is smaller than a radius 6 of the second open end 5.

In order to connect and disconnect the present invention around the flaccid penis of a user, the present invention further comprises a first interface 21, a second interface 22, and at least one fastener 23, seen in FIG. 2 and FIG. 4. The first interface 21 and the second interface 22 allow the tubular brace 1, the domed insert 11, and the flange 18 to be smooth and continuous the internally and externally against skin of the flaccid penis and the surfaces of the orifice of the participant while being separable. The at least one fastener 23 secures the alignment of the tubular brace 1 and the domed insert 11 around the flaccid penis of a user. The at least one fastener 23 comprises at least one first interlocking portion 24 and at least one second interlocking portion 27. The at least one first interlocking portion 24 connects the first interface 21 with the second interface 22. Similarly, the at least one second interlocking portion 27 connects the second interface 22 with the first interface 21.

The present invention separates along the length of the flaccid penis of the user and allows the flaccid penis to comfortably remain within an orifice of the participant with the removal of the present invention as the first interface 21 traverses from the first semicircular half portion 19, along the first elongated half portion 2, and to the first semispherical half portion 12, seen in FIG. 4. A smooth connection between the first interface 21 and the second interface 22 is provided as the at least one first interlocking portion 24 is integrated into the first interface 21. The smooth connection between the first interface 21 and the second interface 22 prevents the flaccid penis and the orifice from getting hurt by the at least one fastener 23. Similarly, the second interface 22 traverses from the second semicircular half portion 20, along the second elongated half portion 3, and to the second semispherical half portion 13, seen in FIG. FIG. 2. The at least one second interlocking portion 27 is integrated into the second interface 22. The first interface 21 and the second interface 22 are connected and disconnected with each other around the flaccid penis of the user as the at least one first interlocking portion 24 and the at least one second interlocking portion 27 are engaged to each other. In the preferred embodiment of the present invention, the at least one first interlocking portion 24 comprises a series of first tabs 25 and a series of first recessed space, and the at least one second interlocking portion 27 comprises a series of second tabs 28 and a series of second recessed spaces 29. The series of first tabs 25 and the series of first recessed spaces 26 are positioned opposite to each other across the first interface 21. The series of second tabs 28 and the series of second recessed spaces 29 are positioned opposite to each other across the second interface 22. Each space from the series of first recessed spaces 26 is engaged by a corresponding tab from the series of second tabs 28. Similarly, each space from the series of second recessed spaces 29 is engaged by a corresponding tab from the series of first tabs 25.

In order to provide more support along the shaft of the flaccid penis of a user, the tubular brace 1 further comprises a first elongated cavity 7, a first rigid member 8, a second elongated cavity 9, and a second rigid member 10, seen in FIG. 7. The first elongated cavity 7 houses the first rigid member 8 and allows the first rigid member 8 to slide within the first elongated half portion 2. Similarly, the second elongated cavity 9 houses the second rigid member 10 and allows the second rigid member 10 to slide within the second elongated half portion 3. The first rigid member 8 and the second rigid member 10 prevents the first elongated half portion 2 and the second elongated half portion 3, respectively, from folding while entering into or being removed from the orifice of the participant. In the preferred embodiment of the present invention, the first rigid member 8 and the second rigid member 10 comprises metal material for sufficient support. The first elongated cavity 7 traverses along and through the first elongated half portion 2 and is positioned offset from the first open end 4. The first rigid member 8 is positioned within the first elongated cavity 7, allowing the first elongated half portion 2 to smoothly enter and exit the orifice of the participant as the first rigid member 8 freely slides within the first elongated cavity 7. Similarly, the second elongated cavity 9 traverses along and through the second elongated half portion 3 and is positioned offset from the first open end 4. The second rigid member 10 is positioned within the second elongated cavity 9, allowing the second elongated half portion 3 to smoothly enter and exit the orifice of the participant as the second rigid member 10 freely slides within the second elongated cavity 9.

Although the invention has been explained in relation to its preferred embodiment, it is to be understood that many other possible modifications and variations can be made without departing from the spirit and scope of the invention as hereinafter claimed.

What is claimed is:

1. An erectile dysfunction assistance device comprises:
a tubular brace;
a domed insert;
a flange;
the tubular brace comprises a first elongated half portion, a second elongated half portion, a first open end and a second open end;
the flange comprises a first semicircular half portion and a second semicircular half portion;
the domed insert comprises a first semispherical half portion and a second semispherical half portion;
the first semispherical half portion being terminally connected to the first elongated half portion, adjacent to the first open end;
the first semicircular half portion being terminally connected to the first elongated half portion, adjacent to the second open end;
the second semispherical half portion being terminally connected to the first elongated half portion, adjacent to the first open end; and,
the second semicircular half portion being terminally connected to the first elongated half portion, adjacent to the second open end.

2. The erectile dysfunction assistance device as claimed as claim 1, wherein the domed insert, the tubular brace, and the flange are made of an elastic and flexible material.

3. The erectile dysfunction assistance device as claimed as claim 2, wherein the elastic and flexible material is silicone.

4. The erectile dysfunction assistance device as claimed as claim 1 comprises:
the domed insert further comprises an insert apex, an insert base, and an outlet aperture;
the insert base being positioned adjacent to the first open end;
the insert apex being positioned opposite to the insert base about the domed insert; and,
the outlet aperture traversing through the insert apex.

5. The erectile dysfunction assistance device as claimed as claim 4 comprises:
a radius of the outlet aperture being smaller than a radius of the second open end.

6. The erectile dysfunction assistance device as claimed as claim 1 comprises:
a first interface;
a second interface;
at least one fastener;
the at least one fastener comprises at least one first interlocking portion and at least one second interlocking portion;
the first interface traversing from the first semicircular half portion, along the first elongated half portion, and to the first semispherical half portion;
the at least one first interlocking portion being integrated into the first interface;
the second interface traversing from the second semicircular half portion, along the second elongated half portion, and to the second semispherical half portion;
the at least one second interlocking portion being integrated into the second interface; and,
the at least one first interlocking portion and the at least one interlocking portion being engaged to each other.

7. The erectile dysfunction assistance device as claimed as claim 6 comprises:
the at least one first interlocking portion comprises a series of first tabs and a series of first recessed spaces;
the at least one second interlocking portions comprises a series of second tabs and a series of second recessed spaces;
the series of first tabs and the series of first recessed spaces being positioned opposite to each other across the first interface;
the series of second tabs and the series of second recessed spaces being positioned opposite to each other across the second interface;
each space from the series of first recessed spaces being engaged by a corresponding tab from the series of second tabs; and,
each space from the series of second recessed spaces being engaged by a corresponding tab from the series of first tabs.

8. The erectile dysfunction assistance device as claimed as claim 1 comprises:
the tubular brace further comprises a first elongated cavity, a first rigid member, a second elongated cavity, and a second rigid member;
the first elongated cavity traversing along and through the first elongated half portion;
the first elongated cavity being positioned offset from the first open end;
the first rigid member being positioned within the first elongated cavity;
the second elongated cavity traversing along and through the second elongated half portion;
the second elongated cavity being positioned offset from the first open end; and,
the second rigid member being positioned within the second elongated cavity.

9. An erectile dysfunction assistance device comprises:
a tubular brace;
a domed insert;
a flange;
a first interface;
a second interface;
at least one fastener;
the tubular brace comprises a first elongated half portion, a second elongated half portion, a first open end and a second open end;
the flange comprises a first semicircular half portion and a second semicircular half portion;
the domed insert comprises a first semispherical half portion and a second semispherical half portion;
the at least one fastener comprises at least one first interlocking portion and at least one second interlocking portion;
the first semispherical half portion being terminally connected to the first elongated half portion, adjacent to the first open end;
the first semicircular half portion being terminally connected to the first elongated half portion, adjacent to the second open end;
the second semispherical half portion being terminally connected to the first elongated half portion, adjacent to the first open end;
the second semicircular half portion being terminally connected to the first elongated half portion, adjacent to the second open end;
the first interface traversing from the first semicircular half portion, along the first elongated half portion, and to the first semispherical half portion;
the at least one first interlocking portion being integrated into the first interface;
the second interface traversing from the second semicircular half portion, along the second elongated half portion, and to the second semispherical half portion;
the at least one second interlocking portion being integrated into the second interface; and,
the at least one first interlocking portion and the at least one interlocking portion being engaged to each other.

10. The erectile dysfunction assistance device as claimed as claim 9, wherein the domed insert, the tubular brace, and the flange are made of an elastic and flexible material.

11. The erectile dysfunction assistance device as claimed as claim 10, wherein the elastic and flexible material is silicone.

12. The erectile dysfunction assistance device as claimed as claim 9 comprises:
the domed insert further comprises an insert apex, an insert base, and an outlet aperture;
the insert base being positioned adjacent to the first open end;
the insert apex being positioned opposite to the insert base about the domed insert;
the outlet aperture traversing through the insert apex; and,
a radius of the outlet aperture being smaller than a radius of the second open end.

13. The erectile dysfunction assistance device as claimed as claim 9 comprises:
the at least one first interlocking portion comprises a series of first tabs and a series of first recessed spaces;
the at least one second interlocking portions comprises a series of second tabs and a series of second recessed spaces;
the series of first tabs and the series of first recessed spaces being positioned opposite to each other across the first interface;
the series of second tabs and the series of second recessed spaces being positioned opposite to each other across the second interface;
each space from the series of first recessed spaces being engaged by a corresponding tab from the series of second tabs; and,
each space from the series of second recessed spaces being engaged by a corresponding tab from the series of first tabs.

14. The erectile dysfunction assistance device as claimed as claim 9 comprises:
the tubular brace further comprises a first elongated cavity, a first rigid member, a second elongated cavity, and a second rigid member;
the first elongated cavity traversing along and through the first elongated half portion;
the first elongated cavity being positioned offset from the first open end;
the first rigid member being positioned within the first elongated cavity;
the second elongated cavity traversing along and through the second elongated half portion;
the second elongated cavity being positioned offset from the first open end; and,
the second rigid member being positioned within the second elongated cavity.

15. An erectile dysfunction assistance device comprises:
a tubular brace;
a domed insert;
a flange;
the tubular brace comprises a first elongated half portion, a second elongated half portion, a first open end and a second open end;
the flange comprises a first semicircular half portion and a second semicircular half portion;
the domed insert comprises a first semispherical half portion, a second semispherical half portion, an insert apex, an insert base, and an outlet aperture;
the first semispherical half portion being terminally connected to the first elongated half portion, adjacent to the first open end;
the first semicircular half portion being terminally connected to the first elongated half portion, adjacent to the second open end;
the second semispherical half portion being terminally connected to the first elongated half portion, adjacent to the first open end;
the second semicircular half portion being terminally connected to the first elongated half portion, adjacent to the second open end;
the insert base being positioned adjacent to the first open end;
the insert apex being positioned opposite to the insert base about the domed insert; and,
the outlet aperture traversing through the insert apex.

16. The erectile dysfunction assistance device as claimed as claim 15, wherein the domed insert, the tubular brace, and the flange are made of an elastic and flexible material.

17. The erectile dysfunction assistance device as claimed as claim 16, wherein the elastic and flexible material is silicone.

18. The erectile dysfunction assistance device as claimed as claim 15 comprises:
a radius of the outlet aperture being smaller than a radius of the second open end.

19. The erectile dysfunction assistance device as claimed as claim 15 comprises:
a first interface;
a second interface;
at least one fastener;
the at least one fastener comprises at least one first interlocking portion and at least one second interlocking portion;
the at least one first interlocking portion comprises a series of first tabs and a series of first recessed spaces;
the at least one second interlocking portions comprises a series of second tabs and a series of second recessed spaces;
the first interface traversing from the first semicircular half portion, along the first elongated half portion, and to the first semispherical half portion;
the at least one first interlocking portion being integrated into the first interface;
the second interface traversing from the second semicircular half portion, along the second elongated half portion, and to the second semispherical half portion;
the at least one second interlocking portion being integrated into the second interface;
the at least one first interlocking portion and the at least one interlocking portion being engaged to each other;
the series of first tabs and the series of first recessed spaces being positioned opposite to each other across the first interface;
the series of second tabs and the series of second recessed spaces being positioned opposite to each other across the second interface;
each space from the series of first recessed spaces being engaged by a corresponding tab from the series of second tabs; and,
each space from the series of second recessed spaces being engaged by a corresponding tab from the series of first tabs.

20. The erectile dysfunction assistance device as claimed as claim 15 comprises:
the tubular brace further comprises a first elongated cavity, a first rigid member, a second elongated cavity, and a second rigid member;
the first elongated cavity traversing along and through the first elongated half portion;
the first elongated cavity being positioned offset from the first open end;
the first rigid member being positioned within the first elongated cavity;
the second elongated cavity traversing along and through the second elongated half portion;
the second elongated cavity being positioned offset from the first open end; and,
the second rigid member being positioned within the second elongated cavity.
